(19) United States
(12) Patent Application Publication
(10) Pub. No.: US 2023/0285938 A1
(43) Pub. Date: Sep. 14, 2023

(54) BIOSILICA-PORATED CATALYTIC COMPOSITE MATERIALS

(71) Applicant: Diatomix Inc., Portland, OR (US)

(72) Inventors: Joshua OLSEN, Portland, OR (US); Nicholas DAY, Portland, OR (US); Abigail PYEATT, Portland, OR (US)

(21) Appl. No.: 18/006,023

(22) PCT Filed: Jul. 16, 2021
(86) PCT No.: PCT/US2021/042070

§ 371 Date: Jan. 19, 2023

Related U.S. Application Data
(60) Provisional application No. 63/054,059, filed on Jul. 20, 2020.

(51) Int. Cl. B01J 21/08; B01J 21/06; B01J 35/02; B01J 35/00; B01J 37/04; B01J 37/00; B01J 37/08; B01D 53/86; C02F 1/30; C02F 1/72; B09C 1/08

(52) U.S. Cl. CPC B01J 21/08; B01D 53/8687; B01J 21/063; B01J 35/004; B01J 35/023; B01J 35/026; B01J 37/0018; B01J 37/04; B01J 37/08; B09C 1/08; C02F 1/30; C02F 1/725; B01D 2255/20707; B01D 2255/802; B01D 2257/708; B01D 2257/93; B01D 2258/06; C02F 2101/30; C02F 2305/10

(57) ABSTRACT

A composition comprising catalytic materials mixed with diatomaceous earth is provided, wherein, when the composition is exposed to irradiance, heat or other necessary activation environmental factors, the composition actively removes and degrades volatile organic compounds and/or metal ions from air or water streams. The composition can contain binding agents, rheology modifiers, and is shaped via compression or molding to be easily handled. Additionally, the composition can be used in forced-air or water streams to actively remove and degraded volatile organic compounds and/or metal ions from air or water streams.

### CROSS-REFERENCE TO RELATED APPLICATIONS

This application claims priority to U.S. Provisional Pat. Application No. 63/054,059, entitled BIOSILICA-PORATED CATALYTIC COMPOSITE MATERIALS, filed Jul. 20, 2020, which is hereby incorporated by reference in its entirety.

### STATEMENT REGARDING FEDERALLY SPONSORED RESEARCH OR DEVELOPMENT

This invention was made with support under the following government contract: 1927040, awarded by the National Science Foundation. The government has certain rights in the invention.

### TECHNICAL FIELD

Disclosed herein are embodiments of a composite catalytic and adsorptive material, a description of the material, compositions of the material, and related methods of using the material in catalytic purification to provide purified air and/or water.

### BACKGROUND

Potential applications of photocatalytic titanium dioxide (TiO₂) suffer from the fact that it comes typically as a nano powdered material. Compaction of TiO₂ by extrusion, molding, or otherwise can help to solve this problem but the compaction process often results in activity loss when compared to the powdered material. A composition of material is disclosed which allows for the compaction of catalytic materials such as TiO₂ while mitigating lost activity, and also maximizing surface area, adsorptivity, porosity, light access, light capture, and mechanical strength of the composition.

Diatomaceous earth is a low density, highly porous, and high surface area biomineral that has existing application as a catalyst support for multiple reasons. Additionally, the diatom shell, or frustule, has a unique evolutionary aspect whereby it grows an intricate pore structure adapted for focusing and trapping incident light for the purpose of photosynthesis. This property is highly unique and only a living organism at this point can grow silica structures small enough to manipulate wavelengths of light in this way. For the above reasons as well as its low cost, diatomaceous earth is an ideal candidate to impart pores into catalytic composites.

### SUMMARY

Disclosed herein are embodiments of a biosilica-porated catalytic gas, liquid, and/or semi-solid stream purification media (also referred to herein as a composition or composite system). The composition includes diatomaceous earth and efficiently decomposes and/or degrades volatile organic compounds (VOCs), odors, bacteriophages, and other airborne contaminants as well as captures metals to remove toxins at a higher rate of activity than would be achieved by a catalyst composite alone (without diatomaceous earth). In one embodiment, the biosilica-porated catalyst composite system is composed of at least one catalyst and at least one species of diatomaceous earth. In some embodiments, the biosilica-porated catalyst composite system comprises multiple catalytic and non-catalytic components, in varying relative concentrations.

Also disclosed herein is a mechanism by which, due to the presence of diatomaceous earth in the catalyst composite system, deeper penetration of fluids (e.g., gasses) and light into the bulk material of the catalyst is facilitated.

Also disclosed herein is a mechanism by which, due to the presence of diatomaceous earth and therefore enhanced porosity in the catalyst composite system, in application, target fluids (e.g., gasses) are made to undergo a turbulent and tortuous path through the catalytic media, increasing contact time of the target contaminant with the catalyst and therefore increasing catalytic activity and decreasing any byproducts released through the process of destruction.

Also disclosed is a method comprising exposing a disclosed catalyst composition to volatile organic compounds in such a manner that the composition is also exposed to sufficient intensity of light, heat, and environmental conditions or a combination thereof which by the catalytic activity of the media degrades the volatile organic compounds to nontoxic gasses.

The foregoing and other objects, features, and advantages will become more apparent from the following detailed description, which proceeds with reference to the accompanying figures.

### BRIEF DESCRIPTION OF FIGURES

The embodiments disclosed herein will become more fully apparent from the following description and appended claims, taken in conjunction with the accompanying drawings.

FIG. 1 depicts a composition including a catalytic compacted composite material and diatomaceous earth dispersed therein. As shown therein, the diatomaceous earth is dispersed throughout the composite material in a substantially homogenous manner.

FIG. 2 depicts a method of purification of an un-pure stream of fluid.

FIG. 3A depicts a pathway of contaminate in a typical catalyst composite.

FIG. 3B depicts a pathway of contaminate in an article (e.g., biosilica-porated catalyst composite) disclosed herein. As shown therein, the pathway through the article is substantially more tortuous than the pathway through a typical catalyst composite.

FIG. 4 depicts the removal of pollutants in a fluid stream via passing through a catalytic compacted composite.

FIG. 5 depicts pelletized articles (e.g., diatomix photocatalyst air filter media), each with the same mass but varying concentration of diatomaceous earth.

FIG. 6A depicts an increase in the adsorption of volatile organic compounds seen with adding diatomaceous earth to the article.

FIG. 6B depicts an increase in the removal rate of volatile organic compounds seen in chamber testing by adding 4% diatomaceous earth to the article.

### DETAILED DESCRIPTION

### Definitions and Overview of Terms

The following explanations of terms and methods are provided to better describe the present disclosure and to guide those of ordinary skill in the art and practice of the present disclosure. The singular forms “a”, “an”, and “the” refer to one or more than one, unless the context clearly dictates otherwise. The term “or” refers to a single element of state, alternative elements or a combination of two or more elements, unless the context clearly indicates otherwise. As used herein, “comprises” means “includes”. Thus, “comprising A or B”, means “including A, B, or A and B”, without excluding additional elements. All references, including patents and patent applications cited herein, are incorporated by reference.

Unless otherwise indicated, all numbers expressing quantities of components, molecular weights, percentages, temperatures, times and so forth, as used in the specification of claims are to be understood as being approximations. Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximations unless the word “about” is used. Further, all ranges include both endpoints.

Unless explained otherwise, all technical and scientific terms used herein have the same meaning as commonly understood by one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting.

Catalysis: The process by which a catalyst lowers the activation energy necessary to perform a reaction. In some embodiments, a catalyst allows the reaction of the nanoparticle to perform reactions at lower temperatures than is typically necessary and/or by using light to overcome the activation energy to produce products.

Photocatalysis: The process by which a catalyst uses light as the source of energy to drive a reaction.

Porated: The process of bestowing poration or forming pores in a material or materials.

### Overview

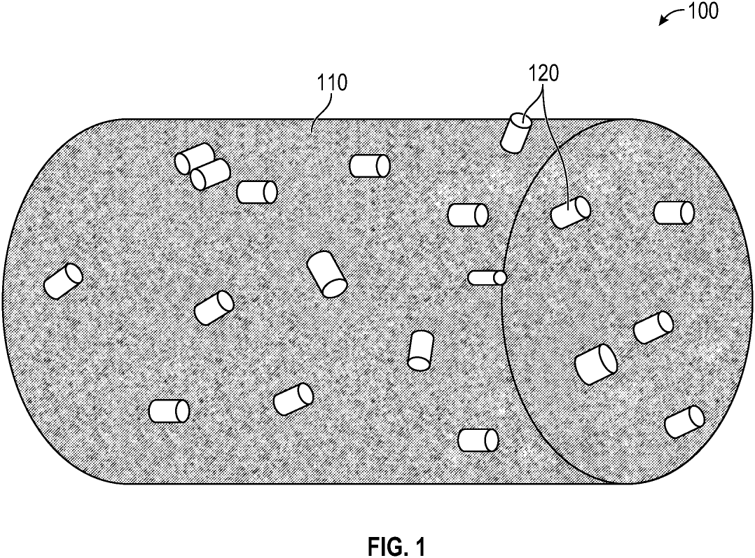

FIG. 1 illustrates an article 100 (e.g., biosilica-porated catalyst composite) comprising a composition 110 and diatomaceous earth 120 of one or more species, either raw or having undergone one or more processing steps, e.g., calcining, flux calcining, washing, acid washing, base washing, oxidizing washing, rinsing, grinding, grading, processing, etc. The composition 110 may be a catalyst mixture (e.g., such as a TiO2-based catalyst mixture) combined with water and mixed into a paste of a predetermined consistency, between 2 million and 2 billion centipoise, such that the composition 110 or material may be molded or extruded using standard industry equipment and techniques with the diatomaceous earth disposed randomly therein. The resulting formed, shaped, molded, or extruded form or article 100, after drying and calcining has good mechanical properties so as to be durable against wear by attrition to which it may be subject during handling, packing, shipping, etc.

The molded or extruded articles 100 may take any shape or dimension which is achievable through currently existing equipment and processes, and by the inherent mechanical properties of the composition 110. An inexhaustive list of shape examples include pellets, rods, tubes, rings, multilobed shapes such as stars and crosses, spheres, cubes, irregular granules, honeycomb structures, bars, and disks. In some embodiments, the cross-sectional dimension of the molded or extruded articles 100 is between about 0.1 mm and about 30 cm. Smaller and/or larger molded extruded articles 100 can also be made. In certain embodiments, the molded or extruded articles 100 comprise a cross-sectional dimension that is between about 0.1 mm and about 1 cm. In some of such embodiments, the molded or extruded articles 100 are cut or otherwise formed to a length of between about 0.25 mm and about 30 cm, or to a length of between about 0.25 mm and about 3 cm.

Diatomaceous earth 120 as used herein comes in enormous variety of species and has multiple sources world-wide, giving a wide range of chemical, physical, and morphological properties on the microscopic level. All varieties will be composed primarily of silica with varying amounts of alumina, iron, and other trace elements. Morphologically it may take many forms with some shapes being barrels, ellipsoids, rods, and disks. Unless specifically stated, the current disclosure claims no particular source or variety of diatomaceous earth 120 as a material component, and so can include all or any of them. In certain embodiments, the diatomaceous earth 120 in the composition comprises barrels. In other embodiments, the diatomaceous earth 120 in the compositions comprises disks. And in yet other embodiments, the diatomaceous earth 120 in the compositions comprises a mixture of one or more of the above-identified shapes (e.g., barrels and disks).

As set forth above, the composition 110 includes one or more catalytic materials, including but not limited to metals, non-metals, and metal oxides. The catalytic materials can form a matrix of the composite material in which the diatomaceous earth 120 is dispersed. Illustrative materials include titanium, manganese, zinc, silicon, chromium, iron, nickel, copper, vanadium, scandium, cobalt, cadmium, hafnium, tantalum, tungsten, rhenium, osmium, iridium, platinum, gold, bismuth, lanthanum, aluminum, silver, ruthenium, nitrogen, carbon, indium, sulfur, phosphorous, and combinations thereof. These materials can also be in their oxide or non-oxide form, such as titanium oxide, zinc oxide, tungsten oxide, silicon oxide, iron oxide and manganese oxide.

The composition 110 can also include one or more reducing or oxidizing agents if desired. Illustrative reducing and oxidizing agents include but are not limited to ascorbic acid, thiosulfate, hydrogen, sugar, starch, oxygen, perchlorate, hypochlorite, chlorate, chlorite, ozone, hydrogen peroxide, permanganate, bromate, iodate, trimethyl amine or redox active metals and non-metal compounds.

In order to increase surface area or porosity of the here disclosed article 100 (e.g., biosilica-porated catalytic composite) beyond that which is provided by the addition of diatomaceous earth 120, disclosed are additional non-catalytic components which may or may not be added in order to create, by the end of processing, void spaces into which light may penetrate and gas may diffuse. Exemplary materials that can be included are those that decompose completely or partially below 800° C. such as ammonium sulfate, urea, sugars, starches, carbon, plastics, polymers or other organic materials and salts.

Other components may be incorporated into the article 100 for the purpose of mechanical strength of an intermediate or the final product as well as rheological and mechanical purposes of producing the composite. In some embodiments, non-catalytic materials which may or may not be included in the present composition 110 include binders. Organic and/or inorganic binders may be used and are configured to improve ductility for extrusion or mechanical strengthening. Organic and/or inorganic binders may include, but are not limited to silica, silica precursors or silica salts and boron or boronic precursors, or boronic salts. Other non-catalytic materials which may be included for rheological modifications to the premanufactured air filter media such as but not limited to organic polymers, salts or metals. In some embodiments, inorganic binders or rheology modifiers are used, including but not limited to salts, organic materials, minerals, and metals, such as sodium silicate, magnesium aluminum silicates, bentonite, boronic acid, borate, sodium borate, silver, gold, aluminum, aluminum oxide, copper, copper oxide, and polymers. In other embodiments, organic binders are used, including but not limited to, polyvinyl alcohol, starches, carboxymethylcellulose, dextrin, wax emulsions, polyethylene glycols, lignosulfates, methylcellulose, polyacrylates, paraffins, peptides, and polyvinyl acetate. Combinations of inorganic and organic binders can also be used.

In some embodiments, one or more trace elements are incorporated into the composite materials of the article 100. Illustrative trace elements include but are not limited to carbon, silicon, nitrogen, fluorine, titanium, manganese, zinc, silicon, chromium, iron, nickel, copper, vanadium, scandium, cobalt, cadmium, hafnium, tantalum, tungsten, rhenium, osmium, iridium, platinum, gold, chlorine, boron, germanium, tin, indium, sulfur, and phosphorous.

In further embodiments, glass or quartz are incorporated into the composite materials of the article 100 in such a manner and concentration that it facilitates the transition of light into the molded or extruded composite materials for increased active photocatalytic surfaces. In certain embodiments, the glass, quartz or salt included are 1 dimensional, such as with a shape of a strand or fiber. The 1 dimensional particles or structures can have a length of between 100 µm to 1 cm, and a cross-sectional thickness of between 20 nm to 250 µm. The cross-sectional thickness can also be at least 100 times smaller than the length. In other embodiments, the glass, quartz or salt included are broadly 2 dimensional, such as with a shape of a sheet or flake. The 2 dimensional particles or structures can have a length and width of between 100 µm to 1 cm, and a thickness of between 20 nm to 250 µm. The thickness can also be at least 100 times smaller than the length. And in yet other embodiments, the glass or quartz included are broadly 3 dimensional, such as glass, quartz, or salt spheres or granules. The 3 dimensional particles or structures can have a length, width and thickness of between 50 µm to 1 cm, and no dimension is more than 25 times larger than another dimension.

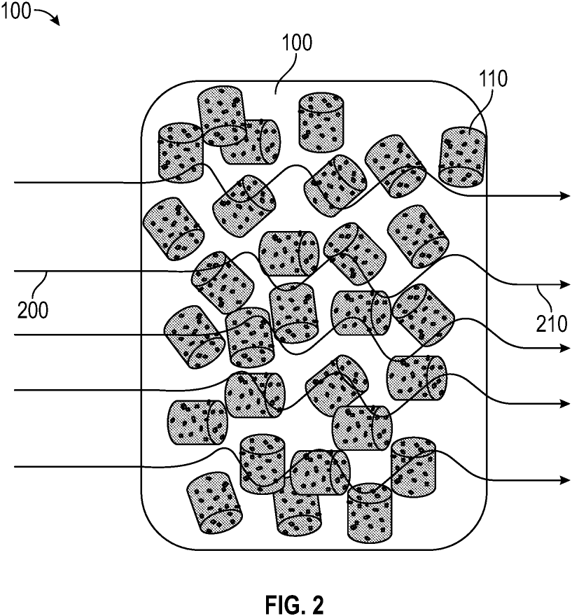

FIG. 2 illustrates a method comprising exposing the article 100 comprising the composition 110 and diatomaceous earth 120 to a stream 200 of gas, liquid, or solids contaminated with an unwanted pollutant, such as a volatile organic compound or a mixture of volatile organic compounds, and exposing the composition while in the stream to appropriate conditions including light, heat, a combination of both light and a certain temperature, pressure, electric field, electric bias, or any combination thereof such that the composition degrades or captures the pollutants and converts the stream 210 to a more purified state. The stream of solids may be a slurry or fluidized solid mixture containing pollutants. The pollutants may comprise volatile organic carbons, hazardous metals, or other dangerous compounds.

The volatile organic compound may be a component of air and in some embodiments, exposing the composition to a stream of air comprising the volatile organic compound and/or metal species. In other embodiments, exposing the composition comprises exposing the composition to a liquid or a stream of liquid comprising volatile organic compounds and/or metal species. Exposing the composition may comprise applying the composition to a surface or larger substrate.

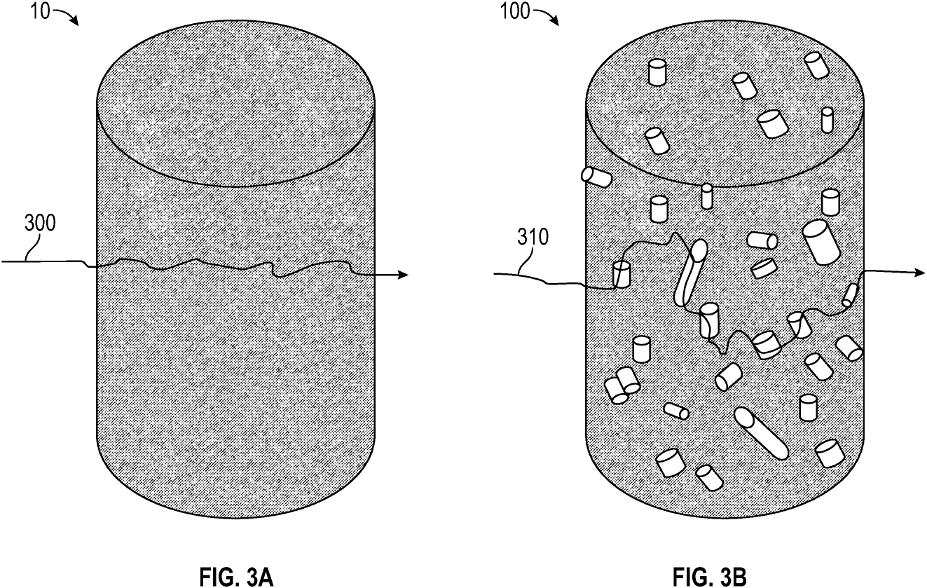

FIG. 3A depicts a pathway 300 of contaminate in a typical catalyst composite 10. FIG. 3B depicts a pathway 310 of contaminate in an article 100 (e.g., biosilica-porated catalyst composite) disclosed herein. As shown therein, the pathway 310 through the article 100 is substantially more tortuous than the pathway 300 through a typical catalyst composite 10.

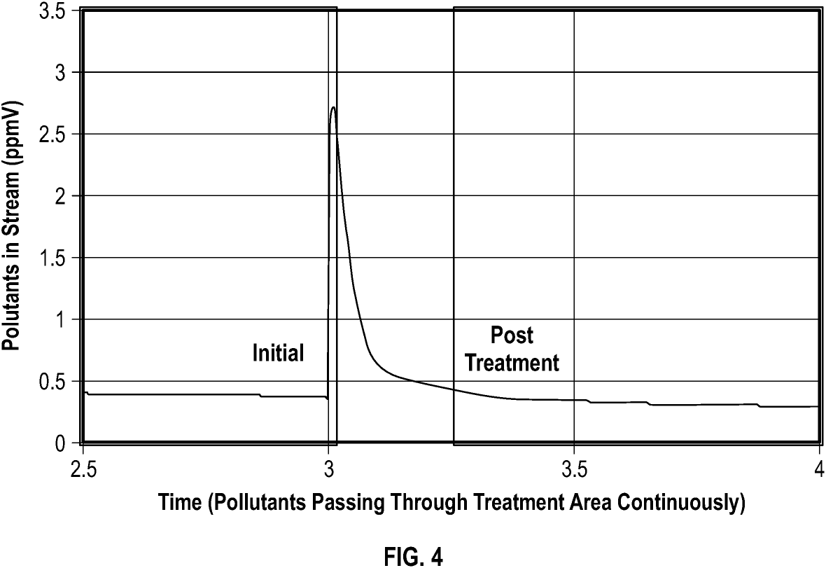

FIG. 4 depicts a time graph of the removal of pollutants in a fluid stream via passing the stream through the article 100. A continuous stream of fluid is depicted at 2.5 hours. At approximately 3 hours, pollutants are injected into the fluid stream which are then quickly removed by the article 100.

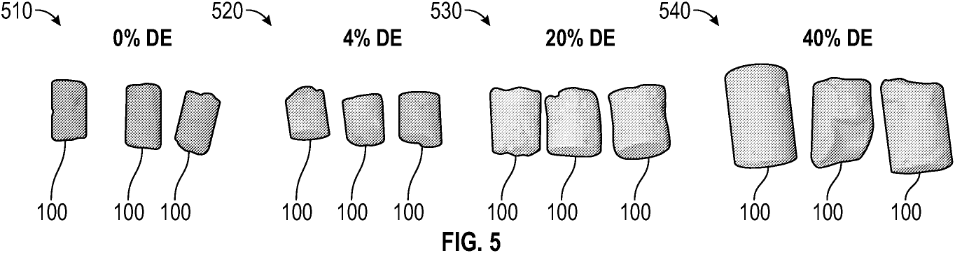

FIG. 5 depicts pelletized articles 100, each with the same mass but varying concentration of identical diatomaceous earth 120. Accordingly, the more diatomaceous earth 120 in the article 100, the more void space the article 100 has resulting in a larger the pellet. Group 510 illustrates three pelletized articles 100 with 0% diatomaceous earth (DE). Group 520 illustrates three pelletized articles 100 with 4% diatomaceous earth. Group 530 illustrates three pelletized articles 100 with 20% diatomaceous earth. Group 540 illustrates three pelletized articles 100 with 40% diatomaceous earth. As illustrated in FIG. 5, the more diatomaceous earth 120 results in an increase in void space and therefore, more volume and a larger pellet.

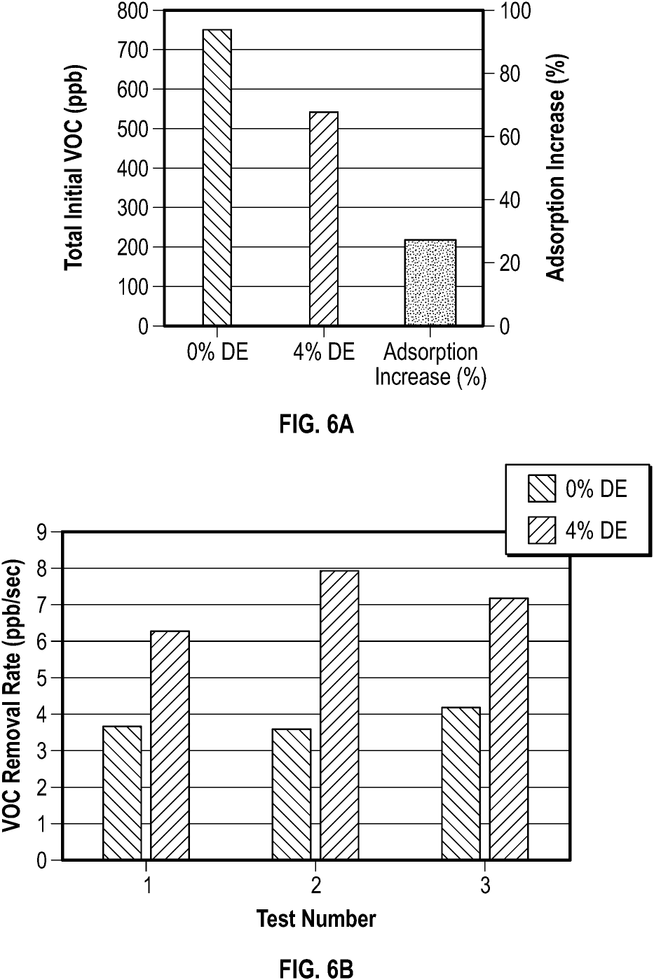

FIG. 6A depicts an increase in the adsorption of volatile organic compounds seen with adding diatomaceous earth 120 to the article 100.

FIG. 6B depicts an increase in the removal rate of volatile organic compounds seen in chamber testing by adding 4% diatomaceous earth to the article 100. In the three tests performed, the article 100 removed at least 6 ppb of volatile organic compounds per second. The article 100 adsorbed 25% more volatile organic compounds and decreased the volatile organic compounds at twice the rate of an article without diatomaceous earth.

### Methods for Making Biosilica-Porated Catalytic Composite

Further disclosed herein are the methods for making the disclosed article 100 or composite. A general method comprises mixing a catalytic slurry of the composition 110 with frustules of diatomaceous earth 120 (diatom frustules) to form an even or homogenous mixture of both components. The catalytic slurry of the composition 110 can be any mixture that when appropriately treated by itself gives a final catalytic system. The diatom frustule of diatomaceous earth 120 can be incorporated at any point before the catalytic mixture of the composition 110 is finished. The catalytic mixture of the composition 110 may comprise any of the following metal, non-metal, metal oxide, non-metal oxide, metal precursor or non-metal precursor components including but not limited to; titanium, manganese, zinc, silicon, chromium, iron, nickel, copper, vanadium, scandium, cobalt, cadmium, hafnium, tantalum, tungsten, rhenium, osmium, iridium, platinum, gold, bismuth, lanthanum, aluminum, silver, ruthenium, nitrogen, carbon, indium, sulfur, or phosphorous.

In some embodiments, the method comprises mixing the diatoms or just diatom frustules of diatomaceous earth 120 with the catalytic precursor or precursors in a solvent or in the absence of a solvent. In certain embodiments, the method is performed with surfactant or surfactants. In further embodiments the diatoms or diatom frustules of diatomaceous earth 120 and catalytic mixture of the composition 110 are mixed in the presence of a binding agent or binding agents. In some embodiments the diatoms or diatom frustules of diatomaceous earth 120 and catalytic mixture of the composition 110 are mixed with multiple components as described above. In further embodiments the multiple components from above can be mixed with either the catalytic mixture of the composition 110 or diatoms or diatom frustules of diatomaceous earth 120 before being mixed with both components.

A general method to form the catalytic compacted composite or article 100 is to then place the mixture in a system to shape the material. In some embodiments, the mixture is placed into a mold or container to allow solvent evaporation, firing or compression for retaining that shape or form the finalized biosilica-porated catalytic composite or article 100. In other embodiments, the catalytic mixture of the composition 110 and diatom mixture of diatomaceous earth 120 is placed into an extruder, press or pelletizer to shape the mixture before drying, firing or compression to retain the desired shape or form the finalized biosilica-porated catalytic composite or article 100.

In some embodiments, the diatom or diatom frustules biosilica-porated catalytic composite or article 100 contains 0.1% to 75% diatom or diatom frustule by weight, between 0.1% to 50% diatom or diatom frustule by weight, or between 2% to 25% diatom or diatom frustule by weight. In some embodiments, the binder or binding agents will not be present in the final catalytic composite.

In some embodiments the biosilica-porated catalytic composite may be heated, pressure treated, dried, vacuum dried or freeze dried after obtaining the desired shape in order to obtain the finalized catalytic composite or article 100. In certain embodiments, the composite of the composition 100 may be heated first to one temperature and then to a second temperature to form the finalized catalytic composite or article 100. In certain embodiments, the first temperature is from greater than 20° C. to less than 1100° C., or from greater than 20° C. to less than 250° C. In certain embodiments the second temperature is from greater than 20° C. to less than 1100° C., or from greater than 300° C. to less than 750° C. In some embodiments, the heating and cooling may be done at a certain rate and held at certain temperatures for a certain period of time. In certain embodiments, the period of time may be from 1 minute to 12 hours. In some embodiments, the time does not include the time taken to reach a certain temperature and in other embodiments the time does include the time taken to reach a certain temperature. In some embodiments the pressure treatment or vacuum drying may be from 0.00013 Pa to 10,000 PSI. In some embodiments, the vacuum drying may be done in combination with freeze drying or heating. In some embodiments, the diatoms or diatom frustules of diatomaceous earth 120 may be heated to a certain temperature and may be allowed to cool before adding to the catalytic composite mixture of the composition 100. In some embodiments the mixture is mixed during heating. In some embodiments, the process of mixing, drying, heating, pressure treating may be repeated multiple time to form layered composite catalyst systems.

In some embodiments, the final catalytic composite or article 100 may be treated with a treatment to add further functionality and improve catalytic performance. The treatment may consist of dipping the final composite or article 100 in a solvent to coat the final composite or article 100 with a compound to give added functionality. The solvent may comprise one or more of starches, amines, sugars, amino acids, or dissolved metals.

In other embodiments, the treatment may be dipping the final catalytic composite or article 100 into a solvent to remove unwanted components of the composite or article 100 to give added functionality. The solvent may comprise one or more acids, bases, oxidants, or reductants. The solvent may comprise one or more of sulfuric acid, acetic acid, nitric acid, hydrochloric acid, perchloric acid, fluoric acid, sodium hydroxide, potassium hydroxide, ammonium hydroxide, tetramethyl ammonium hydroxide, calcium hydroxide, potassium permanganate, ozone, hydrogen peroxide, sodium peroxide, peroxoacetic acid, ascorbic acid, sodium thiosulfate, starch, or sugar.

### Applications of Biosilica-Porated Catalytic Composite and Related Compositions

The disclosed composite catalyst or article 100 offers unique properties and environmentally beneficial functions, superior to small catalytic particles and powders or larger porous catalytic materials. The disclosed biosilica-porated catalytic composites or articles 100 are useful for removing and or partially removing volatile organic compounds for the purpose of purifying air and water. Additionally, the disclosed composition allows streams of air and water to flow through the catalyst composition or article 100 and be treated without the loss or contamination of the stream by particles of the catalyst composite or article 100. Additionally, the size of the biosilica-porated catalytic composite or article 100 allows the safe and easy handling by people and machines to minimize the potential of inhalation, ingestion, or other contact with the material. The disclosed catalytic composition or article 100 may be used to treat or purify water, chemical waste, air, chemically contaminated air, waste streams, ground matter or chemically contaminated ground matter.

In some embodiments, the biosilica-porated catalytic composite or article 100 may be added to air filter, water filter, perforated bags, socks, porous containers or other forms of cartridges that allow the passing of materials such as water, air, trash, waste, or dirt through them. In some embodiments, the biosilica-porated catalytic composite or article 100 will be activated or deactivated by the use of temperature, irradiance, concentration, exposure, pressure, or other chemicals. These activation or deactivation components can be from natural or artificial sources.

In some embodiments, the biosilica-porated catalytic composite or article 100 can be immobilized onto other solid substances through the use of glues, waxes, physical connection, heating, plasticizing, embedding or magnetic interaction to treat contaminated streams. In some embodiments, the material may be mixed using the force of air, water, or magnetism to treat a flowing stream uniformly.

### EXAMPLES

### Example 1: Preparation of Diatoms

Diatoms are cultivated in fields then harvested from the field and purified, separating organic matter and protein from the frustule chemically or thermally. The frustules are then ready for incorporation.

Alternatively, diatomaceous earth can be sourced from several mining companies, world-wide. Diatoms purchased from commercial vendors can be largely not intact and the quality of samples should be checked. Commercially available diatoms can be used as is or thermally treated to remove residual organic matter or adsorbed water.

### Example 2: Synthesis of Metal or Metal Oxide Catalyst Material

Metal precursors can be dissolved in an appropriate solvent depending on solubility. Then the metal precursors can be reduced or oxidized accordingly to produce metal or metal oxide catalyst materials, respectively. Metal and metal oxide catalyst materials can then be dried to an appropriate level for incorporation of diatomaceous earth and molding or extrusion.

### Example 3: Preparation of Biosilica-Porated Catalytic Composite

For one particular pelletized catalytic composite, 100 g of 75% water and 25% titanium dioxide mixture was stirred in an open container to which 1 g of diatomaceous earth from a commercial supplier was added. The combination was then stirred for 10 minutes to obtain a homogenous mixture. The material was then placed into an extruder and extruded to form a thin cylindrical tube which was cut into pellets. The pelletized biosilica-porated catalytic composite was allowed to dry at room temperature for 24 hours and then fired to 600° C. for 10 minutes and allowed to cool to hold the desired shape. The resulting off-white material can be placed into streams and irradiated for contaminant degradation.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description.

Without further elaboration, it is believed that one skilled in the art can use the preceding description to utilize the invention to its fullest extent. The claims and embodiments disclosed herein are to be construed as merely illustrative and exemplary, and not a limitation of the scope of the present disclosure in any way. It will be apparent to those having ordinary skill in the art, with the aid of the present disclosure, that changes may be made to the details of the above-described embodiments without departing from the underlying principles of the disclosure herein. In other words, various modifications and improvements of the embodiments specifically disclosed in the description above are within the scope of the appended claims. Moreover, the order of the steps or actions of the methods disclosed herein may be changed by those skilled in the art without departing from the scope of the present disclosure. In other words, unless a specific order of steps or actions is required for proper operation of the embodiment, the order or use of specific steps or actions may be modified. The scope of the invention is therefore defined by the following claims and their equivalents.

1. A composition, comprising:
diatomaceous earth; and
one or more catalytic metals, non-metals, or metal oxides.

2. The composition of claim 1, wherein the catalytic metal, non-metal, or metal oxide comprises one or more of titanium, manganese, zinc, silicon, chromium, iron, nickel, copper, vanadium, scandium, cobalt, cadmium, hafnium, tantalum, tungsten, rhenium, osmium, iridium, platinum, ruthenium, bismuth, lanthanum, aluminum, silver, gold, nitrogen, carbon, or indium.

3. The composition of any one of claims 1-2, further comprising: a reducing or oxidizing agent.

4. The composition of claim 3, wherein the reducing or oxidizing agent comprises one or more of ascorbic acid, thiosulfate, hydrogen, sugar, starch, oxygen, perchlorate, hypochlorite, chlorate, chlorite, ozone, hydrogen peroxide, permanganate, bromate, iodate, trimethyl amine or redox active metals or non-metal compounds.

5. The composition of any one of claims 1-4, further comprising: one or more trace elements, the one or more trace elements comprising one or more of carbon, silicon, nitrogen, fluorine, titanium, manganese, zinc, chromium, iron, nickel, copper, vanadium, scandium, cobalt, cadmium, hafnium, tantalum, tungsten, rhenium, osmium, iridium, platinum, gold, chlorine, boron, germanium, tin, indium, sulfur, or phosphorous.

6. The composition of any one of claims 1-5, wherein the composition is in a form of molded or extruded articles selected from pellets, rods, tubes, rings, multilobed shapes such as stars and crosses, spheres, cubes, irregular granules, honeycomb structures, bars, and disks.

7. The composition of any one of claims 1-6, wherein the composition is in a form with a length and cross sectional size from 0.1 mm to 30 cm.

8. The composition of any one of claims 1-7, further comprising one or more inorganic binders or rheology modifiers selected from salts, organic materials, minerals, and metals.

9. The composition of claim 8, wherein the one or more inorganic binders are selected from sodium silicate, magnesium aluminum silicates, bentonite, boronic acid, borate, sodium borate, silver, gold, aluminum, aluminum oxide, copper, copper oxide, and polymers.

10. The composition of any one of claims 1-9, further comprising one or more organic binders configured to improve ductility for extrusion or mechanical strengthening.

11. The composition of claim 10, wherein the one or more organic binders are selected from polyvinyl alcohol, starches, carboxymethylcellulose, dextrin, wax emulsions, polyethylene glycols, lignosulfates, methylcellulose, polyacrylates, paraffins, polyvinyl acetate, and peptides.

12. The composition of any one of claims 1-11, further comprising quartz or glass in such a manner and concentration that it facilitates transition of light into the composition for increased active photocatalytic surfaces.

13. The composition of claim 12 wherein the quartz or glass is broadly 1 dimensional.

14. The composition of claim 12 wherein the quartz or glass is broadly 2 dimensional such as glass flake, glass sheets, salt flake or salt sheet.

15. The composition of claim 12 wherein the quartz or glass is broadly 3 dimensional spheres or granules.

16. A composition, comprising:
diatomaceous earth;
one or more catalytic metal, metal oxide, or non-metal; and
water in sufficient quantity that the composition may be mixed into a paste of a predetermined consistency that it may be shaped, formed, molded, or extruded.

17. The composition of claim 16, wherein the catalytic metal, metal oxide or non-metal comprises one or more of titanium, manganese, zinc, silicon, chromium, iron, nickel, copper, vanadium, scandium, cobalt, cadmium, hafnium, tantalum, tungsten, rhenium, osmium, iridium, platinum, gold, nitrogen, ruthenium, aluminum, bismuth, silver, lanthanum, carbon, or indium.

18. The composition of any one of claims 16-17, further comprising a reducing or oxidizing agent selected from ascorbic acid, thiosulfate, hydrogen, sugar, starch, oxygen, perchlorate, hypochlorite, chlorate, chlorite, ozone, hydrogen peroxide, permanganate, bromate, iodate, trimethyl amine or redox active metals or non-metal compounds.

19. The composition of any one of claims 16-18, further comprising one or more trace elements, the one or more trace elements comprising one or more of carbon, silicon, nitrogen, fluorine, chlorine, boron, germanium, tin, indium, sulfur, or phosphorous.

20. The composition of any one of claims 16-19, wherein the composition is in a form of molded or extruded articles selected from pellets, rods, tubes, rings, multilobed shapes such as stars and crosses, spheres, cubes, irregular granules, honeycomb structures, bars, and disks.

21. The composition of any one of claims 16-20, wherein the composition is in a form with a length and cross sectional size from 0.1 mm to 30 cm.

22. The composition of any one of claims 16-21, further comprising one or more inorganic binders configured to improve ductility for extrusion or mechanical strengthening such as: salts, organic materials, minerals, or metals.

23. The composition of claim 22, where the one or more inorganic binders are selected from sodium silicate, magnesium aluminum silicates, bentonite, boronic acid, borate, sodium borate, silver, gold, aluminum, aluminum oxide, copper, and copper oxide.

24. The composition of one of claims 16-23, further comprising one or more organic binders for improving ductility for extrusion or mechanical strengthening.

25. The composition of claim 24, where the one or more organic binders are selected from polyvinyl alcohol, starches, carboxymethylcellulose, dextrin, wax emulsions, polyethylene glycols, lignosulfates, methylcellulose, polyacrylates, paraffins, and polyvinyl acetate.

26. The composition of any one of claims 16-25, further comprising added articles of quartz or glass which are embedded in the composition in such a manner and concentration that it facilitates transition of light into the composition for increased active photocatalytic surfaces.

27. The composition of claim 26, wherein the added articles are broadly 1 dimensional.

28. The composition of claim 26, wherein the added articles are broadly 2 dimensional such as glass flake, glass sheets, salt flake or salt sheet.

29. The composition on claim 26, wherein the added articles are broadly 3 dimensional such as spheres or granules.

30. A method, comprising:
mixing diatom frustules with catalytic precursors in an absence or in a presence of a solvent to create a mixture;
adding the mixture to a mold, extruder, or pelletizer; and
exposing the mixture to an appropriate condition wherein the mixture retains a desired shape.

31. The method of claim 30, wherein the catalytic precursor comprises a metal, non-metal or metal oxide catalyst.

32. The method of any one of claims 30-31, wherein the mixture is allowed to dry to hold the desired shape.

33. The method of any one of claims 30-32, wherein the mixture is extruded to obtain the desired shape.

34. The method of any one of claims 30-33, wherein the mixture is exposed to high pressure to obtain the desired shape.

35. The method of any one of claims 30-34, wherein the mixture is heated to one or more temperatures to form a final composite.

36. The method of claim 35, wherein the final composite is then treated with a treatment to add further functionality and improve catalytic performance.

37. The method of claim 36, wherein the treatment consists of dipping the final composite in the solvent to coat the final composite with a compound to give added functionality.

38. The method of claim 37, wherein the solvent comprises one or more of starches, amines, sugars, amino acids, or dissolved metals.

39. The method of claim 37, wherein the treatment consists of dipping the final composite in the solvent to remove unwanted components of the composite to give added functionality.

40. The method of claim 39, wherein the solvent comprises one or more of acids, bases, oxidants, or reductants.

41. The method of claim 39, wherein the solvent comprises one or more of sulfuric acid, acetic acid, nitric acid, hydrochloric acid, perchloric acid, fluoric acid, sodium hydroxide, potassium hydroxide, ammonium hydroxide, tetramethyl ammonium hydroxide, calcium hydroxide, potassium permanganate, ozone, hydrogen peroxide, sodium peroxide, peroxoacetic acid, ascorbic acid, sodium thiosulfate, starch, or sugar.

42. A method comprising:
exposing the composition of claim 1 to a stream of gas, liquid, or solids contaminated with an unwanted pollutant; and
exposing the composition while in the stream to light, heat, pressure, electric field, electric bias, or any combination thereof such that the composition degrades or captures the pollutants and converts the stream to a more purified state.

43. The method of claim 42, wherein the composition is exposed to a stream of air comprising pollutants.

44. The method of any one of claims 42-43, wherein the composition is exposed to a stream of liquid containing pollutants.

45. The method of any one of claims 42-44, wherein the stream of solid is a slurry or fluidized solid mixture containing pollutants.

46. The method of any one of claims 42-45, wherein the pollutants are comprised of volatile organic carbons, hazardous metals, or other dangerous compounds.
